(19) United States
(12) Patent Application Publication
(10) Pub. No.: US 2016/0130520 A1
(43) Pub. Date: May 12, 2016

(54) COATING MATERIAL OF METAL-PHOSPHATE-BASED CERAMIC COMPLEX HAVING HEAT AND ABRASION RESISTANCE AND LOW FRICTION CHARACTERISTICS AND COATING METHOD THEREOF

(71) Applicant: KOREA INSTITUTE OF SCIENCE AND TECHNOLOGY, Seoul (KR)

(72) Inventors: Ho Sung KONG, Seoul (KR); Hung Gu HAN, Seoul (KR)

(21) Appl. No.: 14/674,544

(22) Filed: Mar. 31, 2015

(30) Foreign Application Priority Data
Nov. 10, 2014 (KR) 10-2014-0155731
Feb. 5, 2015 (KR) 10-2015-0018188

(51) Int. Cl. C10M 125/24; C10M 103/02; B05D 1/00; B05D 1/18; B05D 1/28; C10M 103/06; B05D 1/02

(52) U.S. Cl. CPC C10M 125/24; C10M 103/06; C10M 103/02; B05D 1/02; B05D 1/18; B05D 1/28; B05D 1/007; C10M 2201/0413; C10M 2201/0653; C10M 2201/0663; C10M 2201/0623; C10M 2201/085

(57) ABSTRACT

The present invention relates to a ceramic complex coating material having heat resistance, abrasion resistance, and low friction characteristics and applied on a surface of a rotating shaft to increase resistance of a mechanical element such as a rotating shaft of a turbine or the like in sliding-contact operation at a high speed without oil feeding under high temperature conditions of 400 to 900° C. to friction, heat, and abrasion resulted from contact with a bearing.

The ceramic complex lubricant composition according to an embodiment of the present invention may show an excellent lubrication performance, have a high heat resistance to allow for a continuous use at a temperature of 400° C. or more, and exhibit an excellent abrasion resistance. The composition according to the embodiment of the present invention may be used as a coating lubricant for a surface of many types of sliding members in a turbine shaft for power generation, a skirt member of an automobile engine cylinder, a steel hot rolling plant, wire rod rolling or the like which are driven in a high temperature environment.

### CROSS-REFERENCE TO RELATED APPLICATION

This application claims priority to and the benefit of Korean Patent Application No. 2014-0155731, filed on Nov. 10, 2014 and Korean Patent Application No. 2015-0018188, filed on Feb. 5, 2015, the disclosure of which is incorporated herein by reference in its entirety.

### BACKGROUND 1. Field of the Invention

The present invention relates to a ceramic complex coating material having heat resistance, abrasion resistance, and low friction characteristics and applied on a surface of a rotating shaft to increase resistance of a mechanical element such as a rotating shaft of a turbine or the like in sliding-contact operation at a high speed without oil feeding under high temperature conditions of 400 to 900° C. to friction, heat, and abrasion resulted from contact with a bearing.

2. Discussion of Related Art

The present invention relates to a coating material, and more specifically, to a heat and abrasion resistant metal-phosphate-based ceramic complex coating material of low friction characteristics for a high temperature, which has heat resistance, abrasion resistance, and low friction characteristics and is applied on a surface of a rotor to decrease friction generated at an dynamic machine element such as a rotating shaft of a turbine or the like in rotation operation at a high speed without oil feeding under high temperature conditions of 400 to 900° C. and a bearing which supports the dynamic machine element, and to minimize abrasion generated therebetween, and a method of coating the same.

Generally, a lubrication method of supplying oil or a grease lubricant on a contact surface is used as the lubrication method under conditions of a relatively low rotational speed. However, when a gas having a high temperature of 600 to 1,000° C. or more is absorbed in a gas turbine for power generation, a temperature of shafting of a bearing reaches 400° C. or more due to an influence of a high temperature gas, and thus the above-described conventional method of supplying oil may not be used. When the wet lubrication is impossible, a thin film adhesive solid lubricant in which solid lubricants such as molybdenum disulfide (MoS₂), graphite, polytetrafluoroethylene (PTFE), or the like having excellent lubricity are mixed with a binder bonding agent such as a thermosetting resin such as an epoxy resin, a polyimide resin, or the like may be used. However, there is a problem in that the allowable application temperature is limited to 200 to 300° C. or less.

Regarding a technique of a coating lubricant which may be used under high temperature conditions, the technique related to the thin film adhesive solid lubricant composition including an inorganic bonding agent of a polymer of an alkoxy silane compound and a metal alkoxy compound synthesized by a sol-gel process and a method of preparing the same is disclosed in Korean Patent Publication No. 479901. However, in the case of the above-described lubricant, the normal application temperature is in the range of 250 to 350° C., and the lubricant may be even used momentarily at the temperature in the range of 400 to 500° C., but the above-described lubricant is difficult to sufficiently exhibit satisfactory performance under high temperature conditions (400 to 900° C.) as the lubricant according to an embodiment of the present invention. In the description about the effect of the lubricant according to the embodiment of the present invention, the coating lubricant obtained from the above-described technique and a ceramic complex coating lubricant obtained according to the embodiment of the present invention may be compared in the result of the friction and wear life test thereof.

For effective lubrication of the mechanical elements in contact operation under high temperature conditions of 400° C. or more, methods of mixing nickel-chrome, nickel-cobalt, or nickel-molybdenum-aluminum alloy metal particles; chromium carbide (CrC) or chromium oxide (Cr₂O₃) having excellent heat resistance; and silver (Ag) and an eutectic mixture of barium fluoride (BaF₂)/calcium fluoride (CaF₂) exhibiting excellent lubricity at a high temperature, and coating the surface of the rotating shaft with the same using a plasma spraying method are described in each of U.S. Pat. No. 3,199,934, U.S. Pat. No. 3,419,363, U.S. Pat. No. 5,866,518, and U.S. Pat. No. 8,753,417.

Further, similarly, a method of coating the surface of the rotating shaft with a metal-substrate-composition which includes a bonding agent including nickel (Ni) at 60 to 80 wt %, chrome (Cr) at 20 to 40 wt % in the range of 40 to 60 wt %, chromium oxide (Cr₂O₃) in the range of 20 to 40 wt %, tungsten disulfide (WS₂) in the range of 10 to 20 wt %, and silver in the range of 10 to 20 wt % using a plasma spraying method is described as an effective method of lubricating the rotating shaft operating without oil feeding under high temperature conditions in Korean Patent Publication No. 655366.

Methods of coating the surface with heat-resistant metal bonded lubricant complex particles having an alloy metal as a base material using a plasma spraying method as described in U.S. Pat. No. 3,199,934, U.S. Pat. No. 3,419,363, U.S. Pat. No. 5,866,518, U.S. Pat. No. 8,753,417, and Korean Patent Publication No. 655366 have disadvantages in economical terms in that expensive plasma coating equipment is required, and have problems in technical terms in that the coated surface is uneven, or coating is difficult to be applied in the case in which the surface to be coated is located inside, because a spraying gun is required to maintain a certain distance from the coating surface in a perpendicular direction.

### SUMMARY OF THE INVENTION

When a ceramic binder is used as the coating lubricant for a high temperature, the bonding agent of the ceramic binder forms porous structure having micro-sized pores after heat curing, and thus abrasions take place easily since fine cracks may be easily generated by a repeated contact load, and a base material to be coated may be modified by heat at a high temperature for heat curing. Accordingly, it is preferable to decrease the heat curing temperature, and the lubricant is required to have a desirable combination and content to have a low sliding friction coefficient and long wear life under conditions of friction contact at a high temperature.

Further, the method of easy coating the surface with the solid lubricant using a dipping method, a spray coating method, a roll-coating method, or the like is required.

According to an aspect of the present invention, there is provided a thin film adhesive coating material composition including a metal-phosphate-based ceramic binder at 20 to 35 wt %, a solid lubricant at 10 to 60 wt %, a low melting point metal at 4 to 15 wt %, and a balance of water, more preferably, a ceramic binder at 20 to 30 wt %, a solid lubricant at 20 to 30 wt %, a low melting point metal at 5 to 15 wt %, and a balance of water, and most preferably, a ceramic binder at 25 to 30 wt %, a solid lubricant at 25 to 30 wt %, a low melting point metal at 8 to 12 wt %, and a balance of water, where the low melting point metal forms a cermet with a ceramic. The metal-phosphate is preferably a phosphate of a hydroxide or an oxide of one or more metals selected from the group consisting of magnesium (Mg), aluminum (Al), calcium (Ca), chromium (Cr), silicon (Si), zirconia (Zr), zinc (Zn), molybdenum (Mo), titanium (Ti), and iron (Fe). The component of the solid lubricant is preferably one or more selected from the group consisting of tungsten disulfide (WS₂), molybdenum disulfide (MoS₂), antimony oxide (Sb₂O₃), graphite, graphene, fluorene, lead oxide, titanium oxide, iron oxide, Teflon (PTFE), and boron nitride (BN). The low melting point metal is preferably one or more selected from the group consisting of tin (Sn), lead (Pb), zinc (Zn), and indium (In). Preferably, silver (Ag), gold (Au), or a mixture thereof is further added to the metal-phosphate-based ceramic binder.

According to another aspect of the present invention, there is provided a coating method including (a) obtaining a metal-phosphate-based ceramic binder solution by reacting a metal hydroxide or oxide with a phosphoric acid; (b) obtaining a complex lubricant by adding a solid lubricant to the metal-phosphate-based ceramic binder solution; (c) obtaining a coating material by adding a low melting point metal to the complex lubricant; (d) applying the coating material on a surface of a driving body; (e) drying the applied coating material under conditions of room temperature; (f) gelling the dried coating material by heat curing the dried coating material at a temperature of 200 to 400° C.; and (g) grinding and polishing a surface of the heat-cured coating layer to have a thickness of 40 to 200 μm. Preferably, step (a) further includes diluting a metal-phosphate-based ceramic solution obtained in step (a) with a water solvent; and adding a pH adjuster to the metal-phosphate-based ceramic solution additionally. In step (d), an application method is preferably one or more selected from the group consisting of a spray coating method, a tumbling method, a dipping method, a brushing method, a roll printing method, and a bell type rotary atomizing electrostatic coating method.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a view in which a high temperature reciprocating friction wear tester and a test specimen are exemplified; and

FIG. 2 is a view showing a test result of friction and wear life of a coating specimen according to an embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

Ceramic coating has excellent abrasion resistance, chemical resistance, and oxidation resistance at a high temperature, and may be performed through chemical vapor deposition (CVD), physical vapor deposition (PVD), ion-beam assisted deposition (IBAD), a heat or plasma spray method, a sol-gel method, etc. In the methods, when the sol-gel coating method is used, compositions having various performances may be easily mixed, a surface of a base material may be simply coated only by applying through dipping, spraying, or brushing, and a thermal deformation of the coating layer and base material may be minimized because the coating is performed at a temperature relatively lower than that of the other methods.

According to an aspect of the present invention, there is provided a thin film adhesive coating material composition including a metal-phosphate-based ceramic binder at 20 to 35 wt %, a solid lubricant at 10 to 60 wt %, a low melting point metal at 4 to 15 wt %, and a balance of water, more preferably, including a ceramic binder at 20 to 30 wt %, a solid lubricant at 20 to 30 wt %, a low melting point metal at 5 to 15 wt %, and a balance of water, and most preferably, including a ceramic binder at 25 to 30 wt %, a solid lubricant at 25 to 30 wt %, a low melting point metal at 8 to 12 wt %, and a balance of water, where the low melting point metal forms a cermet with a ceramic.

The thin film adhesive coating material composition according to the embodiment of the present invention includes a metal-phosphate-based ceramic binder at 20 to 35 wt %, more preferably, at 20 to 30 wt %, and most preferably, at 25 to 30 wt %. When the metal-phosphate-based ceramic binder is less than 20 wt %, there are coating defects resulted from a coating layer which is easily peeled off from a surface of a base material after heat curing, and when the metal-phosphate-based ceramic binder is more than 35 wt %, abrasion becomes worse since fine cracks resulted from repeated contact loads are generated after coating.

A metal-phosphate is a representative material which has high mechanical and thermal strength, excellent stability at a high temperature and abrasion resistance, and thus may be used as a heat resistant binder in ceramic materials, and is a material which may be easily coated on the surface of the base material using the sol-gel method.

A metal-phosphate binder may be synthesized by a chemical reaction between a metal hydroxide (e.g., when a metal is aluminum, a metal hydroxide may be aluminum hydroxide (Al(OH)₃)) and a phosphoric acid. As the metal, one or more is preferably selected from the group consisting of magnesium (Mg), aluminum (Al), calcium (Ca), chromium (Cr), silicon (Si), zirconia (Zr), zinc (Zn), molybdenum (Mo), titanium (Ti), and iron (Fe). As an example of the chemical reaction between the metal hydroxide and the phosphoric acid (H₃PO₄), in the case of aluminum phosphate, 1 mol equivalent of aluminum hydroxide is dissolved in deionized water, a phosphoric acid solution in which a molar ratio of aluminum to a phosphoric acid is in the range of about 1:3 to 1.5:3 is added into the solution, the solution is reacted with stirring under conditions of a temperature of 80 to 100° C., and thus aluminum phosphate is obtained.

The metal-phosphate ceramic binder may be diluted with a water solvent, or an alkali compound may be additionally added to the metal-phosphate ceramic binder to adjust a pH value and density of the metal-phosphate binder, and the alkali compound is preferably sodium hydroxide (NaOH).

Another metal hydroxide or oxide may be added in a synthesis reaction of the metal phosphate to improve mechanical stability and thermal stability of the metal phosphate binder, and for example, magnesium oxide (MgO) or/and chromium oxide (CrO₃) may be additionally added together with the aluminum hydroxide. Especially, in the case of a binder synthesized by adding chromium oxide, stability may be increased and corrosion resistance of the coating layer may also be increased. In contrast with aluminum, magnesium, chromium, or the like in the form of a metal oxide has excellent reactivity with a phosphoric acid to form a metal phosphate without being in the form of a metal hydroxide, and a mixture thereof has a hybrid type metal-phosphate structure.

Various solid lubricants of a micro size having excellent lubrication characteristics are added into the ceramic binder solution in a sol state synthesized through the above-described process. The thin film adhesive coating material composition according to the embodiment of the present invention includes a solid lubricant at 10 to 60 wt %, more preferably, at 20 to 30 wt %, and most preferably, at 25 to 30 wt %. When the solid lubricant is included at less than 10 wt %, the abrasion becomes worse since fine cracks resulted from repeated contact loads after coating are generated, and when the solid lubricant is included at more than 60 wt %, there are coating defects resulted from a coating layer which is easily peeled off from the surface of the base material after heat curing. A size of the solid lubricant is preferably in the range of 0.5 to 20 μm, when the size is less than 0.5 μm, lubrication durability decreases, and when the size is more than 20 μm, dispersibility of the solid lubricant decreases. The solid lubricant is preferably one or more selected from the group consisting of tungsten disulfide (WS₂), molybdenum disulfide (MoS₂), antimony oxide (Sb₂O₃), graphite, graphene, fluorine, lead oxide, titanium oxide, iron oxide, Teflon (PTFE), and boron nitride (BN) to be added. Preferably, a metal oxide or a metal having excellent lubricating properties is further added to the solid lubricant to improve abrasion resistance or mechanical strength of the lubricating thin film. The metal oxide having excellent lubricating properties is preferably one or more selected from the group consisting of titanium oxide (TiO₂) and iron oxide (Fe₃O₄), and the metal having excellent lubricating properties is preferably one or more selected from the group consisting of silver (Ag), gold (Au), or a mixture thereof. The metal oxide or metal having excellent lubricating properties has relatively low properties as a lubricant as compared to a typical solid lubricant material such as tungsten disulfide, molybdenum disulfide, or the like, but serves to increase mechanical strength of the coating layer, and thus it is preferable that the metal oxide or metal having excellent lubricating properties is additionally added to the solid lubricant.

The thin film adhesive coating material composition according to the embodiment of the present invention includes a low melting point metal at 4 to 15 wt %, more preferably, at 5 to 15 wt %, and most preferably, at 8 to 12 wt %, where the low melting point metal forms a cermet with a ceramic. When the low melting point metal is included at less than 4 wt %, a brittle fracture of a ceramic material increases, and when the low melting point metal is included at more than 15 wt %, mechanical strength of the coating layer decreases. The low melting point metal is preferably added to the synthesized ceramic binder solution in a sol state. The low melting point metal is preferably one or more selected from the group consisting of tin (Sn), lead (Pb), zinc (Zn), and indium (In). In the case of the ceramic binder synthesized by mixing with the low melting point metal, a cermet type in which low melting point metal particles finally soak into the interface of the ceramic structure which is a porous structure with micro-sized pores after heat curing is performed. Lubricants such as a metal oxide, gold, silver, or the like are not dissolved, but the low melting point metal particles form a cermet type in which metal particles are combined with the ceramic, thereby improving mechanical and thermal stability and exhibiting an excellent effect allowing alleviation of damage due to brittleness of a hard ceramic material. Further, toughness of the synthesized coating layer is increased, and the metal is dissolved and melt-lubricated upon friction contact at a high temperature, and thus, a synergistic effect of decreasing friction may be obtained.

The selection of the solid lubricant, the low melting point metal, and the like is preferably to mix two or more types according to the use. After adding various types of lubrication fillers as described above to the ceramic binder solution synthesized in a sol state, the mixture is evenly mixed with sufficient stirring using a ball milling process, etc.

According to another aspect of the present invention, there is provided a coating method including (a) obtaining a metal-phosphate-based ceramic binder solution by reacting a metal hydroxide or oxide with a phosphoric acid; (b) obtaining a complex lubricant by adding a solid lubricant to the metal-phosphate-based ceramic binder solution; (c) obtaining a coating material by adding a low melting point metal to the complex lubricant; (d) applying the coating material on a surface of a driving body; (e) drying the applied coating material under conditions of room temperature; (f) gelling the dried coating material by heat-curing the dried coating material at a temperature of 200 to 400° C.; and (g) grinding and polishing a surface of the heat-cured coating layer to have a thickness of 40 to 200 μm.

For example, the ceramic coating material in the sol state is mixed with the lubricant, is applied on a surface of a base material which is roughened using a sand blast method or the like through a spraying method, is primarily dried at room temperature, is secondarily heat-cured under temperature conditions of 200 to 400° C. sequentially, and thus an inorganic compound in the sol state is gelled. Accordingly, the cured coating layer has a form in which lubricating materials of a micro size are evenly dispersed in the amorphous metal-phosphate ceramic binder. When the heat curing temperature is less than 200° C., heat curing is insufficiently performed, and thus mechanical strength is decreased, and when the heat curing temperature is more than 400° C., the form of the metal-phosphate ceramic binder gradually becomes a crystal form, and heat resistance is increased, but brittleness is relatively increased.

It is preferable to further dilute the metal-phosphate-based ceramic solution obtained in the above step (a) with a water solvent; and to add a pH adjuster to the metal-phosphate-based ceramic solution additionally. When the metal-phosphate binder is applied on an iron-based base material, the binder forms a strong chemical bond with the surface of the base material, and thus excellent improvement effect of adhesion strength of the coating layer may be obtained. However, when the chemical reaction between the metal-phosphate binder and the iron-based base material is too strong, the surface of the base material are corroded and bubbles are generated, and thus the formation of the coating layer may be disturbed. Accordingly, it is preferable to dilute the metal-phosphate-based ceramic solution with a water solvent to use, or to apply an alkali compound as a pH adjuster to the coating material to increase pH, and the alkali compound is preferably sodium hydroxide (NaOH). Further, for example, before the surface of the iron-based base material is coated with the coating material according to the embodiment of the present invention, it is preferable that a phosphating process or an oxidation process is performed on the surface of the iron-based base material for passivation such that the above-described side effect is minimized. When the phosphating process such as a Zn-phosphating process or a Mn-phosphating process is performed on the iron-based base material, the surface of iron comes to have a porous form with micro-sized pores, and at the same time, a phosphoric acid reacts with iron, oxidation resistance and corrosion resistance are increased, and bonding properties with the ceramic coating layer are increased. The oxidation process is to heat the surface of iron-based base material at a high temperature of about 400 to 500° C., through which iron oxide is generated on the surface of iron, oxidation resistance and corrosion resistance are increased, and at the same time, chemical affinity with the ceramic coating layer is increased.

A method of applying the solid lubricant thin film on the surface of the base material is preferably one or more selected from the group consisting of a spray coating method, a tumbling method, a dipping method, a brushing method, a roll printing method, and a bell type rotary atomizing electrostatic coating method. A thickness of the coating layer may be adjusted by adjusting the number of dipping and spray coating. Machining such as grinding, polishing, or the like is performed on the surface of the complete ceramic coating layer after heat curing, and finally, the ceramic complex lubricant coating layer is complete. The thickness of the lubricant coating layer is preferably in the range of 40 to 200 μm. When the thickness of the coating layer is less than 40 μm, the wear life of the lubricant is decreased, and when the thickness of the coating layer is more than 200 μm, bonding strength between the base material and the coating layer is decreased due to a difference in coefficient of thermal expansion between the coating layer and the base material.

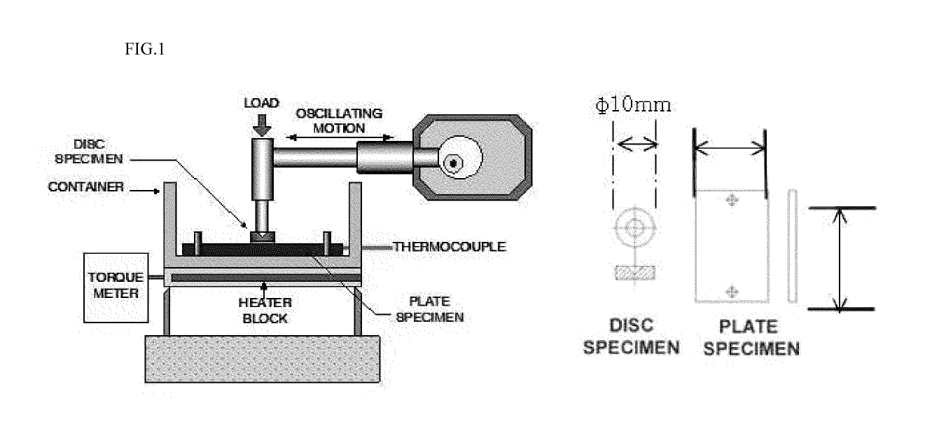

In order to evaluate the friction characteristics and the wear life of the ceramic complex coating material for a high temperature according to the embodiment of the present invention, a high temperature reciprocating friction wear tester (TE77(ASTM G-133); manufactured by Cameron Plint Ltd.) illustrated in FIG. 1 was used. In the test of the friction characteristics and the wear life of the coated lubricant thin film sample, a test load was set to 200 N (contact pressure: 20 kg/cm²), a sliding speed was set to 0.14 m/s (10 Hz), and a temperature of the plate specimen was maintained about 400° C. by heating an electric heater positioned under the test plate specimen.

Table 1 shows the result of the comparison between measured values of the friction coefficient and the wear life of the plate specimen coated with various types of the ceramic complex lubricants. The wear life criterion of the coated specimen was defined to be the number of sliding contact cycles at which the measured average friction coefficient had increased to twice the steady-state value after running-in. For each specimen, the friction tests were repeated three times to ascertain reproducibility. The surface of the base material was pretreated using a sand-blast method such that surface roughness became about Ra=1.0 μm, and the coating lubricants were applied thereon such that a thickness of the lubricant thin film applied on the base material was averagely in the range of about 40 to 200 μm.

TABLE 1

| | | | | | Average | |
|---|---|---|---|---|---|---|
| | | | [Binder | | steady- | |
| | | | to/Lubricant | | state | Average |
| | Type of | | filler] | Coating | coefficient | wear |
| Coating | ceramic | | volume | Thickness | of sliding | life |
| specimen | binder | Type of lubricant | ratio | (μm) | friction | (cycle) |
| Example 1 | Al/Cr/Mg | WS₂ (26.8%) + MoS₂ (4.3%) + | 3:1 | 150 | 0.07 | 55,000 |
| | phosphate | Graphite (2.0%) + Sb₂O₃(1.1%) | | | | |
| Example 2 | Al/Cr/Mg | WS₂ (24.5%) + MoS₂ (10.6%) + | 2:1 | 30 | 0.1 | 45,000 |
| | phosphate | Graphite (5.8%) + Sb₂O₃(4.4%) | | | | |
| Example 3 | Al/Cr/Mg | WS₂ (24.5%) + MoS₂ (10.6%) + | 2:1 | 140 | 0.1 | 130,000 |
| | phosphate | Graphite (5.8%) + Sb₂O₃(4.4%) | | | | |
| Example 4 | Al/Cr/Mg | WS₂ (24.5%) + MoS₂ (10.6%) + | 2:1 | 85 | 0.2 | 100,000 |
| | phosphate | Graphite (5.8%) + Sb₂O₃(4.4%) | | | | |
| Example 5 | Al/Cr/Mg | WS₂ (33.7%) + MoS₂ (14.6%) + | 1:1 | 140 | — | Coating |
| | phosphate | Graphite(7.9%) + Sb₂O₃(6.0%) | | | | defects |
| Example 6 | Al/Cr/Mg | WS₂ (22.9%) + MoS₂ (9.9%) + | 2:1 | 140 | 0.07 | 130,000 |
| | phosphate | Graphite(5.4%) + Sn(10.4%) | | | | |
| Example 7 | Al/Cr/Mg | WS₂ (24.2%) + MoS₂ (10.5%) + | 2:1 | 140 | 0.07 | 80,000 |
| | phosphate | Graphite (5.7%) + Zn (5.6%) | | | | |
| Comparative | Si + Ti | WS₂(20.0%) + Graphite(13.3%) | 3:1 | 40 | 0.07 | 13,000 |
| Example 1 | alkoxide | | | | | |
| Comparative | Si + Ti | WS₂ (16.3%) + MoS₂ (7.0%) + | 3:1 | 100 | 0.17 | 20,000 |
| Example 2 | alkoxide | Graphite (8.3%) + Fe₂O₃ (1.7%) | | | | |
| Comparative | Si + Ti | WS₂ (16.3%) + MoS₂ (7.0%) + | 3:1 | 45 | 0.15 | 13,000 |
| Example 3 | alkoxide | Graphite (8.3%) + Sb₂O₃(1.7%) | | | | |
| Comparative | Si + Ti | WS₂ (16.3%) + MoS₂ (7.0%) + | 3:1 | 100 | 0.12 | 30,000 |
| Example 4 | alkoxide | Graphite(8.3%) + Sb₂O₃ (1.7%) | | | | |

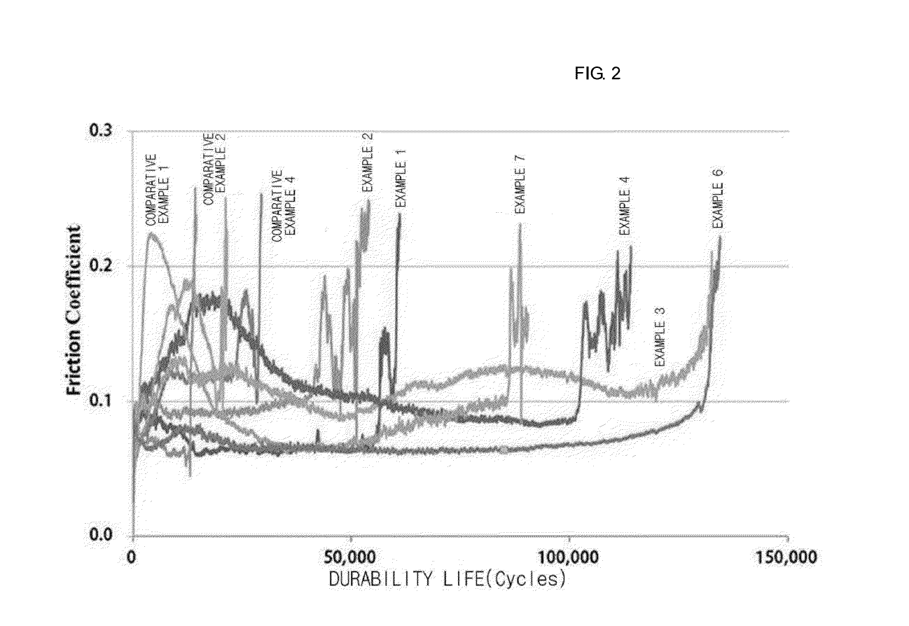

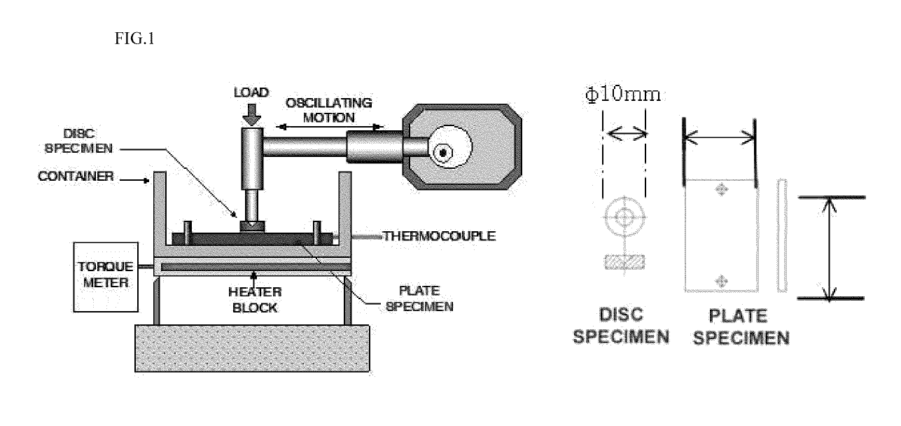

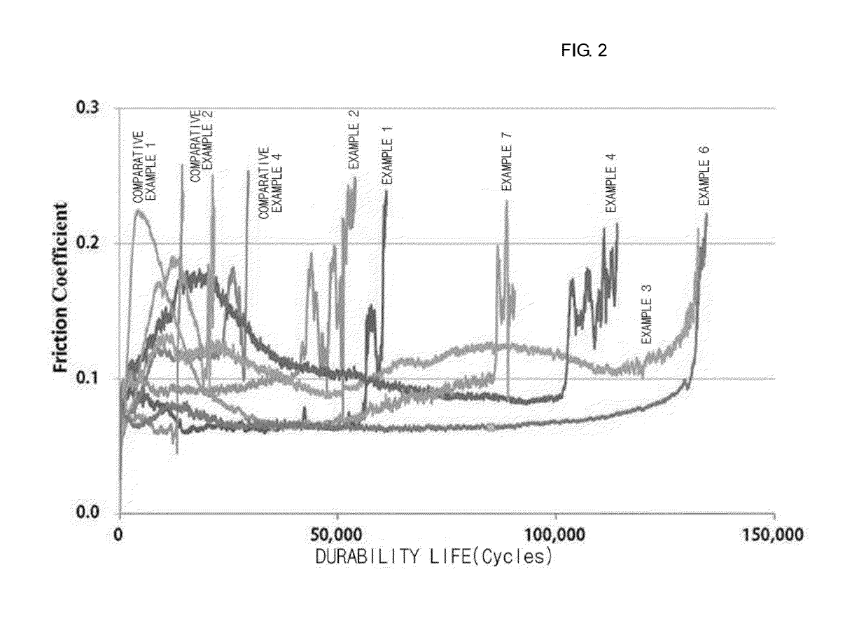

FIG. 2 shows an example of the measurement test result of the friction characteristics of the specimens coated with the ceramic complex lubricant according to the embodiment of the present invention, and it may be determined that, as the test time increases, friction suddenly increases, and at the same time, the lubricant thin film is damaged. In the test result, it may be determined that, the more a volume ratio of the solid lubrication filler according to the embodiment of the present invention increases, the more the wear life of the ceramic complex lubricant according to the embodiment of the present invention increases, and the composition having a volume ratio of the ceramic binder to the solid content of the solid lubrication filler of 2:1 showed the longest wear life. When the mixture ratio of the solid lubrication filler was too high, an amount of the ceramic binder was relatively insufficient, and thus there were coating defects resulted from the coating layer which was easily peeled off from the surface of the base material after heat curing. Further, the wear life of the coating layer was determined to increase approximately in proportion to the thickness of the coating layer. Particularly, as shown in Example 6 of the present invention, when tin particles having a low melting point were added to the ceramic binder, it was determined that the friction coefficient of the coated lubricant was low, and the wear life thereof was long, and this is because the tin particles having a low melting point formed a cermet with the ceramic binder, and thus the mechanical and thermal characteristics of the binder could be increased, and the sliding friction coefficient could be decreased due to the melt-lubrication effect of tin having a low melting point upon the friction contact. Further, in comparative examples of the coefficient of friction and the wear life of the ceramic complex lubricant according to the embodiment of the present invention, the wear life of the ceramic complex lubricant was more excellent than an inorganic lubricant (Si/Ti alkoxide) of the polymer of alkoxy silane-based and metal alkoxy compounds synthesized by a sol-gel process. This is because the ceramic complex lubricant according to the embodiment of the present invention has more excellent heat resistance.

Hereinafter, the present invention will be described in detail in conjunction with examples of the present invention.

### Example 1

147.0 g of a phosphoric acid (H₃PO₄) was put into a 3 neck 1L round bottom flask equipped with a cooling condenser and a thermometer, 25 g of chromium oxide (CrO₃) was dissolved therein, a solution which was formed as a slurry by putting 19.5 g of aluminum hydroxide (Al(OH)₃) into 106 g of distilled water in advance was further added therein, the mixed solution was reacted for about 2 hours with strong stirring while a temperature was maintained in the range of 80 to 100° C. until a transparent solution was obtained, the temperature was lowered to about 60° C., and then the solution which was formed as a slurry by putting 20.15 g of magnesium oxide into 106 g of distilled water in advance was slowly added therein at a certain amount at a time. Here, a temperature may increase due to heat of the reaction, and thus the temperature should be adjusted not to exceed 100° C., the mixed solution was reacted while a temperature was maintained in the range of 80 to 90° C. until the transparent solution was obtained, and thus a complex metal-phosphate of Al (0.5 mol)-Mg (1.0 mol)-Cr (0.5 mol) having the solid content of 50% was synthesized.

A homogeneous lubricant solution was prepared by mixing the metal phosphate synthesized as described above and WS₂ at 26.8 wt %, MoS₂ at 4.3 wt %, graphite at 2.0 wt %, Sb₂O₃ at 1.1 wt %, and the like as solid lubricant components and milling using a milling machine, and then was applied on a surface of a stainless steel specimen forming a clean surface through a sand blasting process, and a solvent cleaning process using normal hexane, acetone, or the like to have a thickness of about 150 μm. A volume ratio of the coated solid content of the binder to the lubricant was 3 to 1. A friction abrasion performance test was performed according to the standard ASTM G-133.

### Example 2

The homogeneous lubricant solution was prepared in the same manner as in Example 1 except that WS₂ at 24.5 wt %, MoS₂ at 10.6 wt %, graphite at 5.8 wt %, Sb₂O₃ at 4.4 wt %, and the like as solid lubricant components were mixed, and the specimen was coated with the solution such that the coating layer had a thickness of about 30 μm, and the test was performed in the same manner as in Example 1. A volume ratio of the coated solid content of the binder to the lubricant filler was 2 to 1.

### Example 3

The solution was prepared and the test was performed in the same manner as in Example 2 except that the thickness of the coating layer of the lubricant was 140 μm.

### Example 4

The solution was prepared and the test was performed in the same manner as in Example 2 except that the thickness of the coating layer of the lubricant was 80 μm.

### Example 5

The homogeneous lubricant solution was prepared in the same manner as in Example 1 except that WS₂ at 33.7 wt %, MoS₂ at 14.6 wt %, graphite at 7.9 wt %, Sb₂O₃ at 6.0 wt %, and the like as solid lubricant components were mixed, and the specimen was coated with the solution such that the coating layer had a thickness of about 140 μm, and the test was performed in the same manner as in Example 1. A volume ratio of the applied solid content of the binder to the lubricant filler was 1 to 1.

### Example 6

The solution was prepared and the test was performed in the same manner as in Example 2 except that Sb₂O₃ of the solid lubricant components was substituted with tin (Sn) which is a soft metal at 10.4 wt %, and the thickness of the coating layer of the lubricant was 140 μm.

### Example 7

The solution was prepared and the test was performed in the same manner as in Example 2 except that Sb₂O₃ of the solid lubricant components was substituted with zinc (Zn) which is a soft metal at 5.6 wt %, and the thickness of the coating layer of the lubricant was 140 μm.

### Comparative Example 1

In order to compare with the metal-phosphate-based ceramic complex coating material according to the embodiment of the present invention, methyltriethoxy silane and tetraethoxy silane were mixed in a weight ratio of 2:1 and were primarily polymerized, and were further mixed with titanium tetrapropoxide in a weight ratio of 3:2, and were secondarily polymerized, and thus a sol-gel inorganic binder was prepared.

Tungsten disulfide at 20.0 wt % and molybdenum disulfide at 13.3 wt % as solid lubricants to be added to the inorganic binder were evenly dispersed using a milling device to prepare the coating lubricant, the lubricant was coated using a spraying method to have a thickness of about 40 μm, the coating layer was cured in an oven adjusted to 200° C. for 1 hour, and then the test was performed in the same method as described above.

### Comparative Example 2

The test was performed in the same manner as in Comparative Example 1 except that tungsten disulfide at 16.3 wt %, molybdenum disulfide at 7.0 wt %, graphite at 8.3 wt %, and iron oxide at 1.7 wt % as solid lubricants were evenly dispersed using a milling device to prepare the coating lubricant, and the lubricant was coated to have a thickness of about 100 μm.

### Comparative Example 3

The test was performed in the same manner as in Comparative Example 1 except that tungsten disulfide at 16.3 wt %, molybdenum disulfide at 7.0 wt %, graphite at 8.3 wt %, and antimony oxide at 1.7 wt % as solid lubricants were evenly dispersed using a milling device to prepare the coating lubricant, and the lubricant was coated to have a thickness of about 45 μm.

### Comparative Example 4

The test was performed in the same manner as in Comparative Example 3 except that the lubricant was coated to have a thickness of about 100 μm.

As the effect of the present invention, the ceramic complex lubricant composition according to the embodiment of the present invention may show an excellent lubrication performance, have a high heat resistance to allow for a continuous use at a temperature of 400° C. or more, and exhibit an excellent abrasion resistance.

The composition according to the embodiment of the present invention may be used as a coating lubricant for a surface of many types of sliding members in a turbine shaft for power generation, a skirt member of an automobile engine cylinder, a steel hot rolling plant, wire rod rolling or the like which are operated in a high temperature environment.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A thin film adhesive coating material composition, comprising a metal-phosphate-based ceramic binder at 20 to 35 wt %, a solid lubricant at 10 to 60 wt %, a low melting point metal at 4 to 15 wt %, and a balance of water, wherein the low melting point metal forms a cermet with a ceramic.

2. The composition of claim 1, wherein the metal-phosphate is a phosphate of a hydroxide or an oxide of one or more metals selected from the group consisting of magnesium (Mg), aluminum (Al), calcium (Ca), chromium (Cr), silicon (Si), zirconia (Zr), zinc (Zn), molybdenum (Mo), titanium (Ti), and iron (Fe).

3. The composition of claim 1, wherein a component of the solid lubricant is one or more selected from the group consisting of tungsten disulfide (WS₂), molybdenum disulfide (MoS₂), antimony oxide (Sb₂O₃), graphite, graphene, fluorene, lead oxide, titanium oxide, iron oxide, Teflon (PTFE), and boron nitride (BN).

4. The composition of claim 1, wherein the low melting point metal is one or more selected from the group consisting of tin (Sn), lead (Pb), zinc (Zn), and indium (In).

5. The composition of claim 1, wherein titanium oxide (TiO₂), iron oxide (Fe₃O₄), silver (Ag), gold (Au), or a mixture thereof is further added to the solid lubricant.

6. A coating method, comprising:
(a) obtaining a metal-phosphate-based ceramic binder solution by reacting a metal hydroxide or oxide with a phosphoric acid;
(b) obtaining a complex lubricant by adding a solid lubricant to the metal-phosphate-based ceramic binder solution;
(c) obtaining a coating material by adding a low melting point metal to the complex lubricant;
(d) applying the coating material on a surface of a driving body;
(e) drying the applied coating material under conditions of room temperature;
(f) gelling the dried coating material by heat-curing the dried coating material at a temperature of 200 to 400° C.; and
(g) grinding and polishing a surface of the heat-cured coating layer to have a thickness of 40 to 200 μm.

7. The method of claim 6, further comprising:
diluting a metal-phosphate-based ceramic solution obtained in the step (a) with a water solvent; and
adding a pH adjuster to the metal-phosphate-based ceramic solution additionally.

8. The method of claim 6, wherein an application method in the step (d) is one or more selected from the group consisting of a spray painting method, a tumbling method, a dipping method, a brushing method, a roll printing method, and a bell type rotary atomizing electrostatic coating method.
